(19) United States
(12) Patent Application Publication
(10) Pub. No.: US 2007/0194909 A1
(43) Pub. Date: Aug. 23, 2007

(54) METHOD AND APPARATUS FOR SENSING AND DETECTING PHYSICAL, BIOLOGICAL AND CHEMICAL CHARACTERISTICS OF A PERSON

(76) Inventors: Michael Garfield, Oviedo, FL (US); David Flinchbaugh, Orlando, FL (US)

Correspondence Address: GRAY ROBINSON, P.A., P.O. Box 2328, FT. LAUDERDALE, FL, 33303-9998, US

(21) Appl. No.: 11/675,691

(22) Filed: Feb. 16, 2007

Related U.S. Application Data
(60) Provisional application No. 60/774,280, filed on Feb. 16, 2006.

(51) Int. Cl. G08B 19/00; G06F 19/00; G06K 9/00; G08B 23/00

(52) U.S. Cl. 340/521; 340/573.1; 382/115; 702/19; 702/22

(57) ABSTRACT

This invention is directed to an apparatus and method for sensing and detecting a number of physical, biological and chemical characteristics of a person, preferably in connection with the process of verifying the identity of the individual. The apparatus may be employed as part of the check-in procedures at airports, bus stations, train stations, cruise ships and other vessels, as well as other situations where identification verification may be required, e.g. banking transactions and the like.

### FIELD OF THE INVENTION

This invention relates to a sensing and detecting apparatus and method, and, more particularly, to a method and apparatus for sensing and detecting a variety of physical, biological and chemical characteristics of an individual during the course of identification verification while traveling, conducting a bank transaction and other situations where proof of identification may be required.

### BACKGROUND OF THE INVENTION

The increasingly violent, persistent and widespread activity of terrorists and other fanatical elements of many societies has required the development of countermeasures to enhance the security of travelers, both internationally and domestically, as well as citizens engaged in their day-to-day lives. Perhaps the most visible increase in security has taken place at airports where luggage is now routinely subjected to X-ray, and passengers are directed through metal detectors while their carry-on bags are X-rayed and physically searched for unapproved items. Some airports have automated sensors to detect the presence of explosive materials on one's person, while others use handheld sensing devices which employ wipes to swab items carried by a passenger to check for explosives.

The danger posed by terrorists and others is not limited to explosives or weapons such as firearms, knives etc. carried on an airplane, bus, vessel or the like. On the contrary, chemical and biological weapons may of even greater concern because the number of people potentially at risk may be far in excess of those passengers on an airplane or other mode of transportation carrying the terrorist(s).

In addition to the intentional infliction of harm to citizens of our country, biological threats from contagious diseases such as avian flu, malaria, small pox, severe acute respiratory syndrome (SARS) and others may be introduced to our population from international visitors. The number of flights and vessels arriving from foreign countries each day is significant, and individuals entering the country may be carrying serious disease, with or without their knowledge, placing our citizens at risk.

### SUMMARY OF THE INVENTION

This invention is directed to an apparatus and method for sensing and detecting a number of physical, biological and chemical characteristics of a person, preferably in connection with the process of verifying the identity of the individual. The apparatus may be employed as part of the check-in procedures at airports, bus stations, train stations, cruise ships and other vessels, as well as other situations where identification verification may be required, e.g. banking transactions and the like.

In one presently preferred embodiment, the apparatus comprises a monitoring station and an analysis center. The individual is prompted to look at a screen during which time his or her photograph is taken and a temperature profile of the skin of at least the upper torso is sensed. The person is required to place his or her fingers on one or more touch pads at the monitoring station which may be equipped with sensors capable of detecting the presence of biological agents and chemical agents on the fingers and remainder of the hands. Additional sensors have the capability of detecting the fingerprints of the subject while they are present on the touch pad.

The goal of the invention is to provide authorities with data, as close to real time as possible, which is collected by the sensors, cameras and other detection equipment at the monitoring stating. This data is sent to an analyzing center, coupled to the monitoring station, for comparison with existing data bases. For example, the photograph and fingerprints of the individual may be compared with national and/or international data bases of known terrorists and criminals who may otherwise be using forged passports, driver's licenses or other identification papers. The biological and chemical sensors are effective to detect trace amounts of different agents on the person of the individual. The analysis center may be housed at the monitoring station, or the data may be transmitted from the monitoring station to one or more remote locations for analysis depending on the type and complexity of the analysis required.

The results of the analysis may be used to prevent a passenger from boarding a particular mode of transportation, or conducting a financial transaction, for example, or it may be used to track an individual entering or leaving the country. For example, it is contemplated that temperature profile data would be immediately analyzed at or near the monitoring station so that a person with a high fever, for example, would be prevented from boarding a vehicle until examined by appropriate medical personnel. It may take more time to evaluate and analyze data relating to physical characteristics of a person, or the biological and chemical agents which they may have on their person, and in those instances threats identified from such analysis could be addressed by authorities waiting at the destination of the vehicle.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a schematic, side view of the apparatus of this invention depicting an individual located at the monitoring station with his hands on the touch pad of the device;

FIG. 2 is a front view of the apparatus shown in FIG. 1;

FIG. 3 is an enlarged, plan view of the touch pad illustrated in FIG. 2;

FIG. 4 is a block diagram of the sensor array located at the monitoring station and the analysis center coupled thereto; and

FIG. 5 is schematic view of nano-tubes which may be associated with the touch pad.

### DETAILED DESCRIPTION OF THE INVENTION

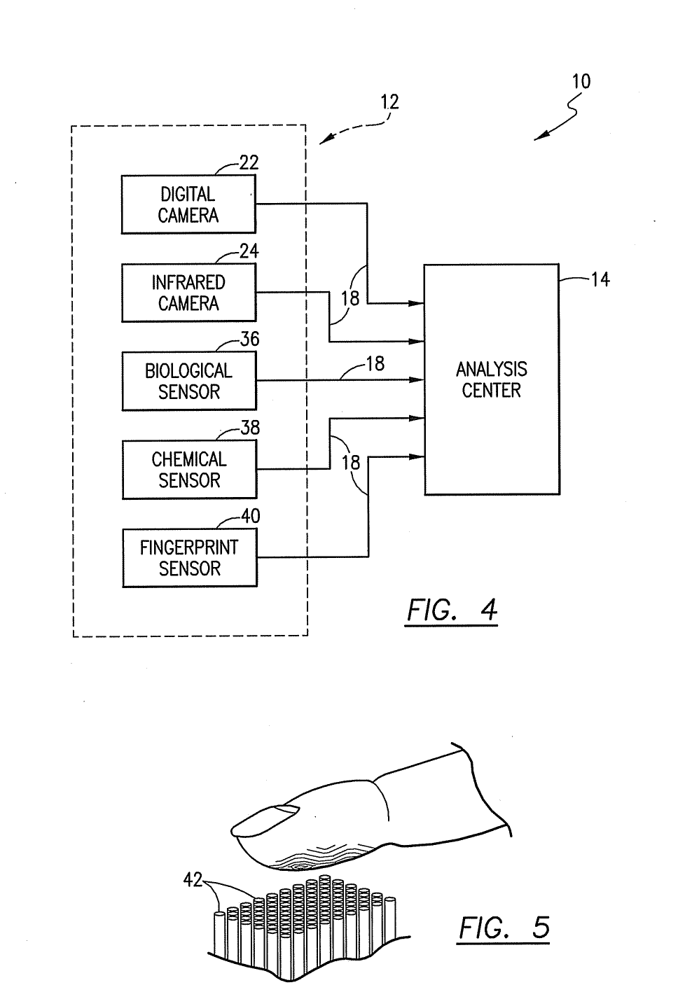

Referring now to the drawings, an apparatus 10 is schematically depicted for sensing and detecting various physical, chemical and biological characteristics of a person. The apparatus 10 includes a monitoring station 12 and an analysis center 14 which may be located in a common housing 16, or the analysis center 14 may be at one or more remote locations. In the event the analysis center(s) 14 is remotely located, it may be coupled to the monitoring station 12 via the Internet, through RF or similar transmissions or other suitable means. See arrows 18 in FIG. 4.

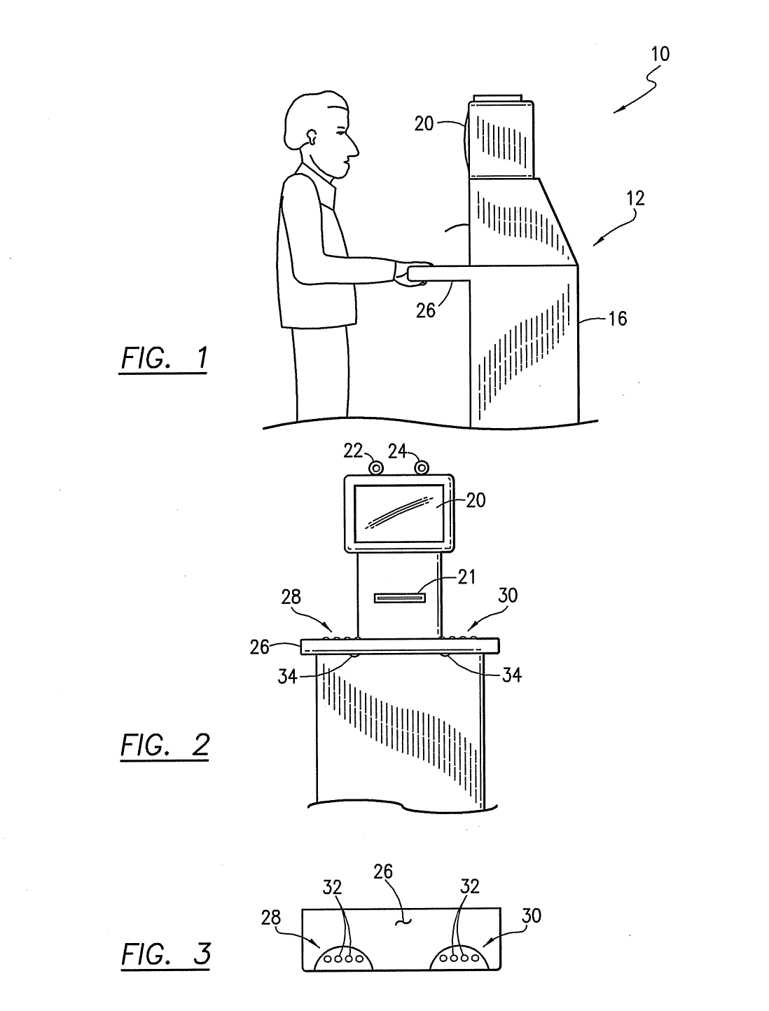

In one presently preferred embodiment of the apparatus 10, the housing 16 mounts a display screen 20 which supports a digital camera 22 and an infrared camera 24, as best seen in FIG. 2. A ledge 26 extends outwardly from the housing 16, and its top surface mounts two touch pads 28 and 30. Each of the touch pads 28 and 30 may have a contact 32 for each of the fingers of one's hand, and a contact 34 for the thumb is positioned on the lower surface of the ledge 22. If the apparatus 10 is intended for use at an airport, for example, the housing 16 may include a slot 21 through which a boarding pass may be dispensed after completion of the passenger monitoring procedure, described in detail below.

With reference to FIG. 4, in addition to the digital camera 22 and infrared camera 24 the monitoring station 12 may include a biological sensor 36, a chemical sensor 38 and a fingerprint sensor 40 depicted schematically in block form in the Fig. The biological sensor 36 and chemical sensor 38 are associated with the touch pads 28, 30, and/or thumb contacts 34. They may take a variety of forms, each capable of sensing or detecting biological or chemical agents which are present on the fingers and hand of a person who uses the apparatus 10, as discussed below. One preferred form of the sensors 36 and 38 is an LOC, e.g. “lab-on-a-chip.” LOC devices integrate multiple laboratory functions on a single chip, typically of only a few millimeters in dimension, and are capable of detecting a variety of chemical and biological agents. Nano-tubes 42, or other sub-micrometer or nano-sized channels, may be employed as a means of transfer of biological and/or chemical agents from the fingers at their point of engagement with contacts 32 and 34 to the LOC or other analysis device. See FIG. 5.

One or more of the contacts 32 on the touch pads 28 and 30, as well as the thumb contact 34, may include a fingerprint sensor 40 such as disclosed, for example, in U.S. Pat. No. 6,672,174, the disclosure of which is incorporated by reference in its entirety herein. It is also contemplated that the fingerprints of one using the apparatus 10 may be digitally photographed at the touch pads 28 and 30 with sufficient detail to permit a comparison with fingerprints in existing data bases.

The apparatus 10, and method of detecting and sensing physical, biological and chemical characteristics of a person, operates as follows. The apparatus 10 may be located at an airport, train station, bus station, pier or any other facility where verification of the identity of a person may take place. The person is initially instructed to approach the apparatus 10 and place his or her hands in the position shown in FIG. 1, i.e. with the fingers of the left hand atop the contacts 32 of touch pad 28, the fingers of the right hand atop the contacts 32 of touch pad 30 and the thumbs atop the thumb contact 34 so that the ledge 26 is grasped between the thumb and fingers. In this position, the head of the person faces the display screen 20. The apparatus 10 is operable to cause prompts to appear on the display screen 20, such as instructions to grasp the ledge 26 as noted above, and this draws the attention of the person directly to the screen 26 so that his or her face is clearly visible.

At this juncture, the digital camera 22 is operated to take one or more photos and produce a signal representative of the image of at least the head of the subject which is transmitted to the analysis center 14. The infrared camera 24 is also actuated while the subject views the display screen 24, and it functions to produce a signal representative of the temperature profile of the person from the exposed areas of skin at least in the area of the head and neck. It is contemplated that the analysis center 14 may include software capable of interpreting the signal from the infrared camera 24 nearly immediately so that if a person has a high fever, typical of a potentially serious disease, he or she may be taken to a separate area for examination by medical personnel. Identification of an individual from the data provided by the digital camera 22 may well take more time than would elapse between a person's monitoring by apparatus 10 and the departure of the particular vehicle he or she is traveling on. However, the digital signal of the person's image may be transmitted via the Internet or other means to a central data base, e.g. part of the “analyzing center 14” as that term is used herein, for comparison with national and/or international data bases. By the time the airplane, vessel, bus etc. reaches its destination, the identity of each person screened by the apparatus 10 may be determined, and local authorities can be alerted to meet such person(s), if necessary.

As noted above, the biological sensor 36, chemical sensor 38 and fingerprint sensor 40 are associated with the touch pads 28 and 30 as well as the thumb contact 34. Engagement of the person's hands, e.g. fingers and thumbs, with these sensors 36, 38 and 40 initiates a sensing and detection sequence capable of identifying various biological agents such as anthrax, SARS, avian flu, malaria, small pox etc., and different types of harmful chemical agents such as nerve gas, ricin, explosives and the like. The biological and chemical tests may be performed using one or more LOCs, nano-sensors or other sensing or detection devices. The fingerprints of the subject may also be obtained by operation of the fingerprint sensor 40 as noted above.

The data obtained from the apparatus of this invention is useful to both identify the identity of an individual, and to determine if the subject may be carrying, or at least has been exposed to, potentially dangerous biological and/or chemical agents. It is intended to provide additional layers of protection to the security measures already in place at such venues as airports and the like, and allow authorities to track individuals of interest.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. Apparatus for detecting and sensing physical, biological and chemical characteristics of a person, comprising:
a monitoring station having an array of sensors and detectors, including:
(i) a digital camera capable of producing a signal representative of the image of at least the head of a person;
(ii) an infrared camera capable of producing a signal representative of the temperature profile of the skin of at least the head of a person;
(iii) a biological sensor operative to contact the hands of a person and produce a signal representative of the presence of biological agents;
(iv) a chemical sensor operative to contact the hands of a person and produce a signal representative of the presence of chemical agents;
(v) a fingerprint sensor operative to produce a signal representative of the image of the fingerprints of a person;
an analyzing center coupled to said monitoring station, said analyzing center being effective to compare said signals received from said array of sensors and detectors with reference data bases to determine the identity of a person, the biological agents present on a person and the presence of chemical agents on a person.

2. The apparatus of claim 1 in which said monitoring station includes a housing having a display screen and at least one touch pad.

3. The apparatus of claim 2 in which said monitoring station produces prompts on said display screen, said prompts causing a person to view said display screen so that his or her head may be photographed by said digital camera and so that a temperature profile of the skin of the head of said person may be taken by said infrared camera.

4. The apparatus of claim 3 in which said prompts appearing on said display screen cause a person to engage said at least one touch pad with his or her hands including the fingers.

5. The apparatus of claim 4 in which said biological sensor is associated with said touch pad and is effective to sense the presence of biological agents present on the hand including the fingers of a person.

6. The apparatus of claim 4 in which said chemical sensor is associated with said at least one touch pad and is effective to sense the presence of biological agents present on the hand including the fingers of a person.

7. The apparatus of claim 4 in which said fingerprint sensor is associated with said at least one touch pad and is effective to produce a digital signal representative of the appearance of the fingerprints of the hand in contact with said touch pad.

8. A method of detecting and sensing physical, biological and chemical characteristics of a person, comprising:
(a) providing a monitoring station having an array of sensors and detectors;
(b) operating a camera located at the monitoring station which is effective to produce a signal representative of the image of at least the head of a person;
(c) operating an infrared camera at the monitoring station which is effective to produce a signal representative of the temperature profile of a person at the monitoring station;
(d) operating a biological sensor located at the monitoring station which is effective to produce a signal representative of the presence of biological agents on the hands of a person at the monitoring station;
(e) operating a chemical sensor located at the monitoring station which is effective to produce a signal representative of the presence of chemical agents on the hands of a person at the monitoring station;
(f) operating a fingerprint sensor located at the monitoring station which is effective to produce a signal representative of the appearance of the fingerprints of a person at the monitoring station; and
(g) providing an analyzing center, coupled to the monitoring station, which is effective to receive the signals produced in steps (b), (c), (d), (e) and (f) and provide an analysis of physical, biological and chemical characteristics of a person based on said signals.

9. The method of claim 8 in which step (d) includes providing a touch pad at the monitoring station with which the biological sensor is associated and with which at least the fingers of a person come into contact.

10. The method of claim 8 in which step (e) includes providing a touch pad at the monitoring station with which the chemical sensor is associated and with which at least the fingers of a person come into contact.

11. The method of claim 8 in which step (f) includes providing a touch pad at the monitoring station with which the fingerprint sensor is associated and with which at least the fingers of a person come into contact.

12. The method of claim 8 in which step (g) includes providing an analyzing center which is located remotely from the monitoring station.
